(19) United States
(12) Patent Application Publication
(10) Pub. No.: US 2010/0324948 A1
(43) Pub. Date: Dec. 23, 2010

(54) MANAGING EVENT TIMELINES

(75) Inventors: Vinod Kumar, Bothell, WA (US); Mary E. Kroening, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/487,212

(22) Filed: Jun. 18, 2009

(51) Int. Cl. G06Q 10/00

(52) U.S. Cl. 705/7

(57) ABSTRACT

The present invention extends to methods, systems, and computer program products for managing event timelines. Embodiments of the invention can be used to generate a dynamic task list (or progress indicator) that shows what tasks have been completed, tasks that can be done now, and remaining tasks. Thus, the task list acts as a guide and a measure of progress. The task list also increases the chance that tasks are completed in the proper order. Accordingly, the configuration of a task list provides utility to both experienced, professional producers as well as the do it yourself producer. Users can use the task list to drive their event management or they can ignore it.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Computer systems can also be used to assist in conducting of events such as, for examples, industry presentations, parties, fund raisers, etc. Events can be online (e.g., electronic attendance) and/or offline (in-person attendance). These and other similar types of events are usually conducted in the context of a timeline, which can include promoting the event, gathering information (via registration), and following up with attendees. However, the timeline for event management can be somewhat (and depending on the type of event increasingly) complex. For example, a timeline can have multiple paths, numerous interdependencies, and span a potentially long period of time (e.g., months).

Conducting an event can require an event producer (and delegated team members) to manage various event components, such as, for example, opening/closing registration, opening/closing physical premises (e.g., a lobby), sending electronic mails (e.g., invitations, reminders, follow-ups, etc.). For some event components, the event producer performs various (required and/or optional), and potentially interdependent actions, to manage the event components. For example, to “open registration” for an event, an event producer can selected a date, send electronic and other communication indicating the event is going to occur, activate electronic registration functionality, make downloadable materials available, etc. Selecting a date may be a required action to open registration. On the other hand, making downloadable available materials may be an optional action to open registration (although may be required at some later time). For example, materials may not even be available until after speakers are arranged.

As such, conducting an event can include performing actions to complete various tasks in specified orders. For example, signing up speakers for an event likely cannot occur until a date and time for the event is finalized. Accordingly, an event timeline can be used to attempt to indicate the timing of when various actions are to be performed. However, as time progresses, actions are performed to complete current tasks, dependencies change, etc., the tasks to be performed at any specified point on the event timeline can change. Further, actions can be completed in a variety of different ways, such as, for example, automatically by a computer system, manually by a human user, or through the passage of time. Completion of a task can also remove or add dependencies to tasks, transition other tasks to required or optional, etc.

Thus, maintaining an accurate timeline that identifies and appropriately updates tasks prior to, during, and after an event can be relatively (and potentially very) difficult. Unfortunately, existing event management techniques and event management software modules typically include canned timelines. These canned timelines have limited, if any, functionality to address the complexities and potential for changed circumstances associated with managing events.

### BRIEF SUMMARY

The present invention extends to methods, systems, and computer program products for managing event timelines. In some embodiments, a workflow is maintained for an event. A workflow is accessed. The workflow is configured to represent the current status of plurality of interdependent tasks for managing the event. One or more actions are received from each of a plurality of different entities acting upon the workflow. At least two of the plurality of different entities having different roles for participating in the event. The received actions correspond to tasks that are currently relevant to management of the event.

For each task included in the plurality of interdependent tasks, the workflow is analyzed to determine if a combination of received actions are indicative of the task being completed. The configuration of the workflow is adjusted to update the status of the plurality of interdependent tasks based on the received actions and based on the indicated completion of any tasks.

From a workflow, a task list can also be maintained. A workflow is accessed. The workflow represents a plurality of interdependent tasks for managing the event. A task list is presented. The task list is populated with a first one or more tasks from the workflow. The first one or more tasks are currently relevant to management of the event. One or more actions are received. The one or more actions indicate that the first one or more tasks are no longer currently relevant to management of the event. The workflow is updated to indicate that the first one or more tasks are no longer currently relevant to management of the event.

The workflow is analyzed to formulate the priority of any remaining non-completed tasks subsequent to updating the workflow. The formulated priority for each remaining non-completed task based on: a) the dependency of the non-completed task on any previously completed tasks, b) the designated importance of the non-completed task, and c) the time differential between the current date and time and the scheduled data and time.

The task list is updated by populating the task list with a specified number of higher priority non-completed tasks. Accordingly, the task list reflects tasks that are currently relevant to management of the event in view of the received one or more actions. The updated task list is presented, including the specified number of higher priority non-completed tasks, at a display device. Presenting the updated task list provides an indication that the specified number of higher priority non-completed tasks is currently relevant to management of the event. As such, the updated task list provides a guide to managing the event.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates managing event timelines.

FIG. 1B illustrates an example of event data that can be used to create an event.

FIG. 1C illustrates an example of a workflow that can be used to maintain a task list for an event.

FIG. 1D illustrates an example of a task list and calendar that can be used to as a guide to managing an event.

FIG. 2 illustrates a flow chart of an example method for maintaining a task list for an event.

FIG. 3 illustrates a flow chart of an example method for maintaining a workflow for an event.

### DETAILED DESCRIPTION

The present invention extends to methods, systems, and computer program products for managing event timelines. In some embodiments, a workflow is maintained for an event. A workflow is accessed. The workflow is configured to represent the current status of plurality of interdependent tasks for managing the event. One or more actions are received from each of a plurality of different entities acting upon the workflow. At least two of the plurality of different entities having different roles for participating in the event. The received actions correspond to tasks that are currently relevant to management of the event.

For each task included in the plurality of interdependent tasks, the workflow is analyzed to determine if a combination of received actions are indicative of the task being completed. The configuration of the workflow is adjusted to update the status of the plurality of interdependent tasks based on the received actions and based on the indicated completion of any tasks.

From a workflow, a task list can also be maintained. A workflow is accessed. The workflow represents a plurality of interdependent tasks for managing the event. A task list is presented. The task list is populated with a first one or more tasks from the workflow. The first one or more tasks are currently relevant to management of the event. One or more actions are received. The one or more actions indicate that the first one or more tasks are no longer currently relevant to management of the event. The workflow is updated to indicate that the first one or more tasks are no longer currently relevant to management of the event.

The workflow is analyzed to formulate the priority of any remaining non-completed tasks subsequent to updating the workflow. The formulated priority for each remaining non-completed task based on: a) the dependency of the non-completed task on any previously completed tasks, b) the designated importance of the non-completed task, and c) the time differential between the current date and time and the scheduled data and time.

The task list is updated by populating the task list with a specified number of higher priority non-completed tasks. Accordingly, the task list reflects tasks that are currently relevant to management of the event in view of the received one or more actions. The updated task list is presented, including the specified number of higher priority non-completed tasks, at a display device. Presenting the updated task list provides an indication that the specified number of higher priority non-completed tasks is currently relevant to management of the event. As such, the updated task list provides a guide to managing the event.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations (e.g., have one or more processors and system memory), including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

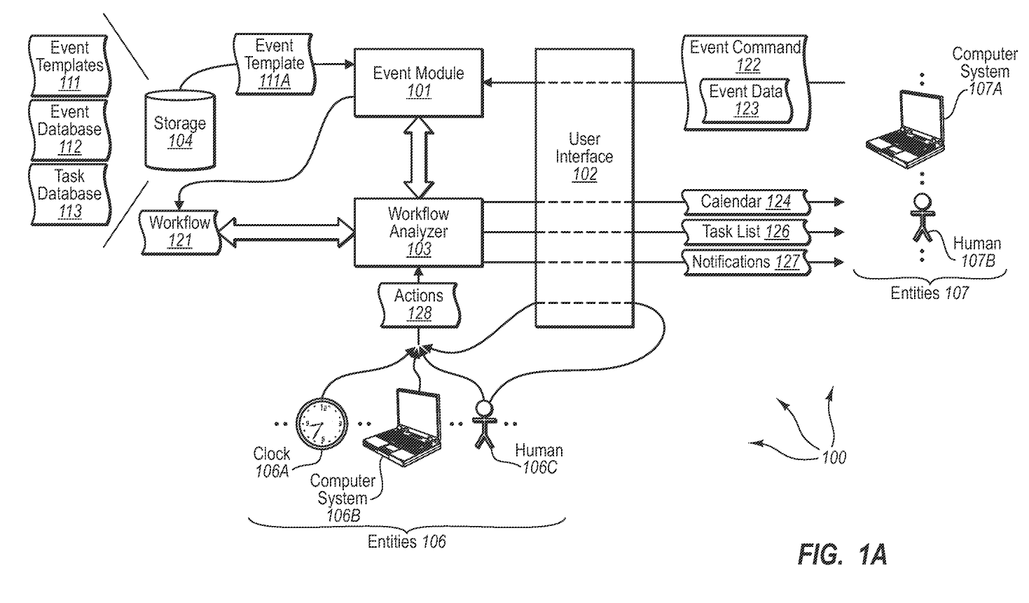

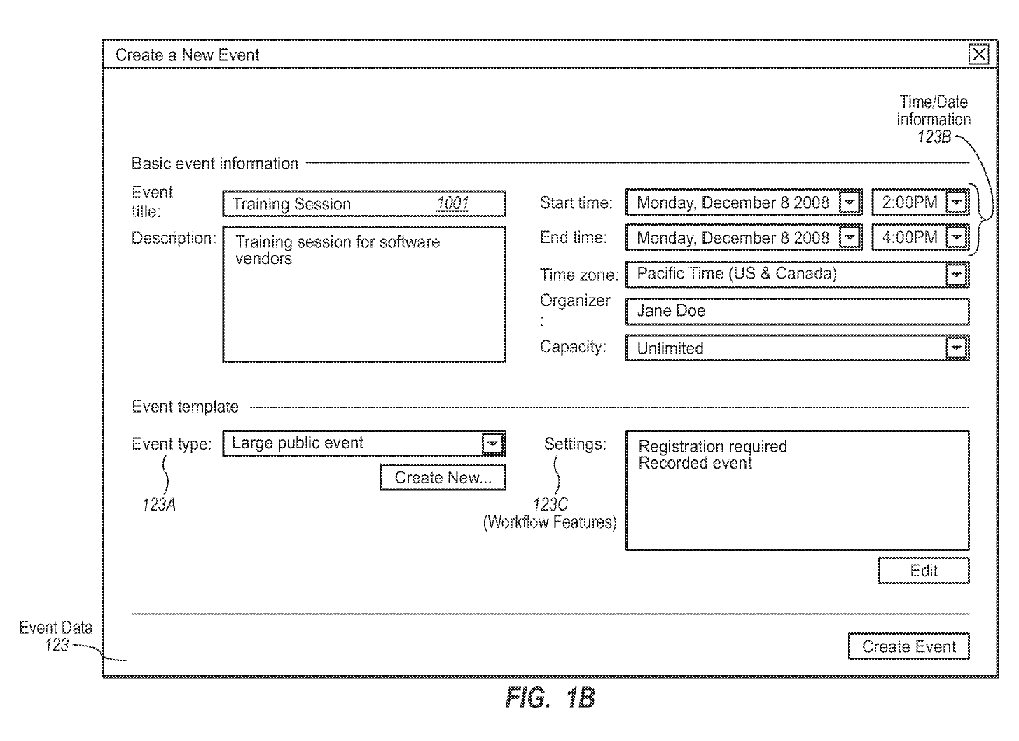

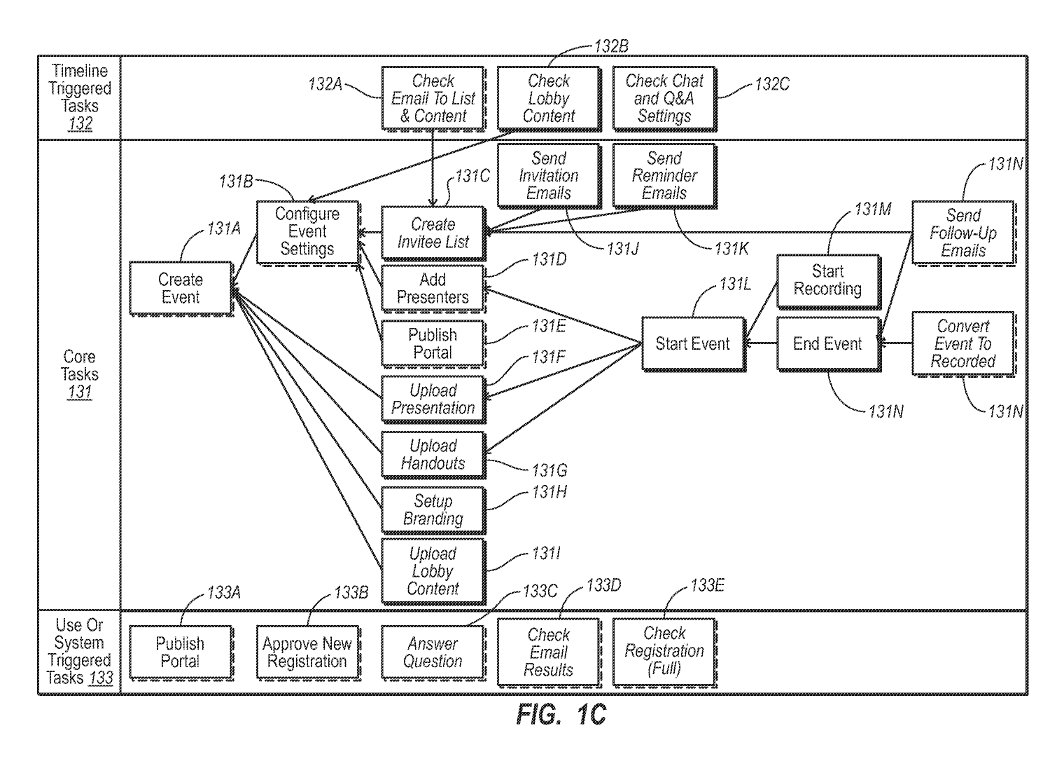

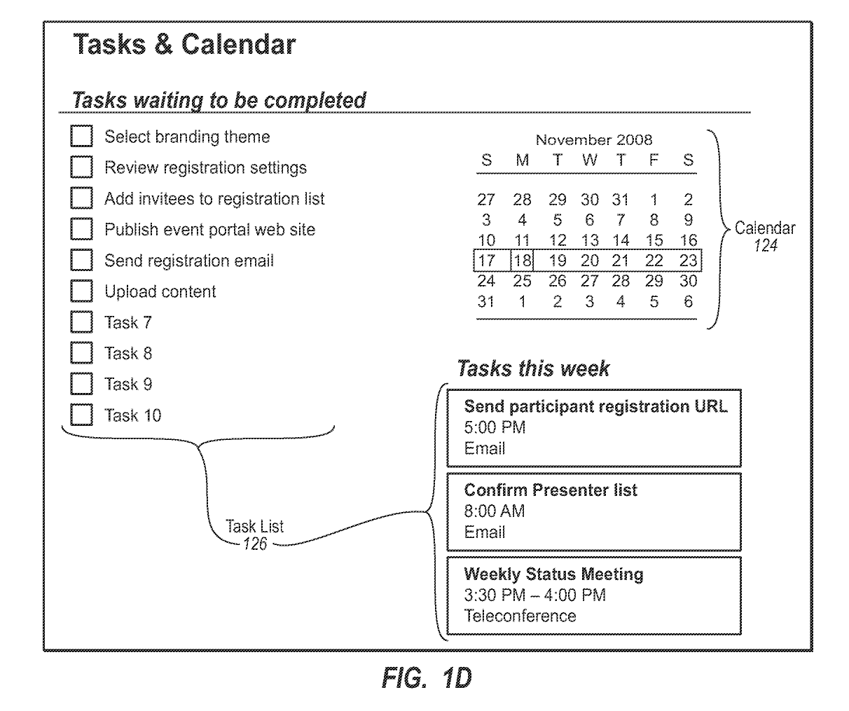

FIG. 1A illustrates an example computer architecture 100 that facilitates managing an event. Referring to FIG. 1A, computer architecture 100 includes event module 101, user interface 102, workflow analyzer 103, and storage 104. Each of the depicted components is connected to one another over (or is part of) a network, such as, for example, a Local Area Network (“LAN”), a Wide Area Network (“WAN”), and even the Internet. Accordingly, each of the depicted computer systems as well as any other connected computer systems and their components (e.g., in entities 106 and 107), can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, user interface 102 interfaces with computer users, such as, for example, human 107B. User interface 102 is configured to receive user input (e.g., through input devices, such as, a keyboard, mouse, etc.) and provide the user input to modules of computer architecture 100. For example, user interface 102 can receive event commands (e.g., event creation, modification, deletion) and provide the event commands to event module 101. User interface 102 can also receive user actions and provide the user actions to workflow analyzer 103. User interface 102 is also configured to receive output from modules of computer architecture 100 and provide the output to computer users (e.g., at a display device, audio device, etc.). For example, user interface 102 can receive calendars, task lists, and notifications and present them at a display device.

Modules of computer architecture 100 can also receive inputs directly from other computer systems. For example, workflow analyzer 103 can receive actions from computer system 106B or clock 106A.

Generally, event module 101 is configured to receive event commands, such as, for example, event creation, event modification, and event deletion commands. Event module can implement the intent of the received event commands. For example, event module 101 can receive event command 122 from human 107B. Event command 122 includes event data 123. Event data 123 contains parameters relevant to event command 122. For example, when event command 122 is a “create event” command, event data 123 can include a start and stop time, a time zone, an event organizer, a title, a description, an event type (i.e., a workflow template identifier), and one or more event settings (i.e., workflow features).

FIG. 1B illustrates an example of event data 123 that can be used to create an event. As depicted, event data 123 includes event type 123A (Large Public Event), time/date information 123B, and settings 123C. Event type 123A can be used to identify a workflow template for large public events workflow. Settings 123C indicate that the workflow is to include tasks for requiring registration and for recording the event.

Storage 104 is a general purpose durable storage device, such as, for example, a magnetic hard disk. As depicted, storage 104 stores event templates 111, event database 112, and task database 113. Event templates in event templates 111 can be used to generate event workflows. An event template can include instructions for building a workflow to include default tasks for a specified type of event. Additional settings (e.g., settings 123C) can be used to customize an event workflow generated from an event template. For example, additional settings can be used to add, remove, or modify default tasks included in an event workflow for a specified type of event.

Event database 112 can store a list of events the computer architecture is 100 is currently managing. Event database can maintain an event ID (e.g., name or other ID) to workflow mapping so that event commands can be directed to workflows using a corresponding event ID.

Task database 113 stores tasks that can be include in workflows. In some embodiments, each task is represented using a data structure. The data structure can include one or more fields, and in some embodiments is of the following format:

| Field Name | Data Type | Description |
|---|---|---|
| Task Name | varchar | A display name |
| Required | Boolean | An indication of whether the task is |
| | | required or options. If TRUE the task is |
| | | required. If FALSE the task is optional |
| Phase | Int | An indication of whether the task is a pre |
| | | event, in event, or post event task. For |
| | | example, 1 = Pre, 2 = In, and 3 = Post |
| Importance | Int | An indication an assigned importance of the |
| | | task. Higher values can indicate a increased |
| | | importance (and thus an increased chance |
| | | for inclusion in a task list and presentation |
| | | closer to the top of the task list). An |
| | | importance value can be initialized during |
| | | workflow creation. The importance value |
| | | can be updated (either manually or |
| | | automatically) as the workflow progresses |
| | | based on changed circumstances |
| | | surrounding an event. |
| Role | List( ) | A list of roles that can perform the task. |
| | | Roles can be selected from among all |
| | | participants, approved participants, |
| | | registered participants, attendees, company, |
| | | presenters, producer, mail handler |
| | | registration handler, etc. |
| Dependent | List( ) | A list of dependent tasks to be completed |
| Tasks | | before the task is initiated. |
| Trigger | Action | An action that triggers initiation of the task. |
| Task State | Int | An indication of the state of the task. States |
| | | can include 1 = Pending (to be done), 2 = |
| | | waiting (waiting for dependent task |
| | | completion), 3 = done, 4 = skipped, etc. |
| Auto Mark | Boolean | An indication of whether the task can be |
| Done | | auto marked as done. If TRUE task can be |
| | | auto marked. If FALSE task cannot be auto |
| | | marked. |
| UI Menu Area | varchar | An indication of a UI area where the task |
| | | can be performed. |

A task can be initiated upon completion of one or more dependent tasks (without having trigger action). Similarly, a task can be initiated upon completion of trigger action (without having any dependent tasks). Further, task initiation can be considered based on a combination of dependent tasks and a trigger action combined either conjunctively or disjunctively. For example, initiation of a task can depend on completion of one or more dependent tasks AND a trigger action. Alternately, initiation of a task can depend on completion of one or more dependent tasks OR a trigger action.

Accordingly, event module 101 can utilize event data 123 to retrieve event template 111A (the event template for a Large Public Event) from event templates 111. Event template 111A can be used to create a workflow of standard tasks (accessed from task database 113) for managing a Large Public Event. From event template 111A, event module 101 can create workflow 121 for managing the event defined by event data 123. Event module 101 can also customize workflow 121 to include other tasks (accessed from task database 113) corresponding to required registration and event recording (in accordance with settings 123C).

Generally, a workflow can be configured as a hybrid polyarchical tree. The hybrid polyarchical tree represents task dependencies stratified across different types of triggers. The tree is polyarchical thus permitting a node to depend from a plurality of other nodes (i.e., each child node can refer to a plurality of parent nodes). The tree is hybrid in that tasks are also stratified by trigger type. Accordingly, a workflow can represent both task dependencies and trigger types for tasks together. It may be that some tasks for an event do not depend on other tasks for initiation. These tasks can be represented in the tree without connection to any other node

FIG. 1C illustrates an example of workflow 121 that can be used to maintain a task list for an event. As depicted in workflow 121, tasks are stratified between core tasks 131 (including tasks 131A through 131P, timeline triggered tasks 132 (including tasks 132A though 132C), and user or system triggered tasks 133 (including tasks 133A through 133E). Arrows between the various tasks indicate dependencies. For example, sending reminder emails 131K is dependent on sending invitations emails 131J and creating an invitee list 131C. Some tasks, such as, for example, approve new registration 133B and check chat Q & A settings do not depend on other tasks.

Likewise some tasks initiated by a triggering action and some tasks are not. For example, answer question 133C is initiated by a user triggered action. However, starting recording 131M is not initiated from a triggering action. Further, tasks depend form other tasks and are initiated by a triggering action. For example, publish portal 133A is dependent on configure event settings 131B and is triggered by a user or system action. As previously described, dependencies and triggers can be considered either conjunctively or disjunctively when determining if a task is to be initiated.

Generally, workflow analyzer 103 is configured to receive actions and analyze an event workflow based on the received actions. From the analysis, workflow analyzer 103 can maintain a calendar and task and issue notifications for a corresponding event. Analysis of an event workflow can include processing received actions (and/or event commands) in view of the current state of the event workflow to determine how received actions (and/or event commands) alter the event workflow. For example, when a task is completed, workflow analyzer 103 can initiate other tasks depending from the completed task. Similarly, when a trigger is received, workflow analyzer can initiate a task in response to the trigger.

Workflow analyzer 103 can also manage workflow state for a workflow. Workflow state can include what tasks have been completed, what triggers have been received, etc. Workflow analyzer 103 can include logic for maintaining calendars and task lists and sending notifications based both on workflow state and data in task data structures. Thus, when maintaining calendars and task lists and sending notifications, workflow analyzer 103 can consider whether a task is optional or required, what other tasks a task depends on, and what triggers a task.

Thus, if a dependent task depends on multiple other tasks (as indicated in a task data structure), workflow analyzer 103 can track completion of each of the other multiple tasks. When all of the multiple dependent tasks are completed, workflow analyzer 103 can initiate the dependent task. For example, referring back to FIG. 1C, workflow analyzer 103 can track the completion of add presenters 133D, upload presentation 131F, and upload handouts 131G for determining when to initiate start event 131L.

Workflow analyzer 103 can also include logic for processing both conjunctive and disjunctive combinations of task dependencies and triggers when maintaining calendars and task lists and sending notifications. Workflow analyzer 103 can also include logic for changing task priorities based on workflow state. For example, as the start time for an event approaches, workflow analyzer can increase the importance of uncompleted required tasks (e.g., adding presenters) that starting the event depends on.

Workflow analyzer 103 can also identify potential dependency violations and notify a user as appropriate. A dependency violation can be identified when received actions indicate performance of a task that is dependent on one or more other uncompleted tasks. For example, referring to FIG. 1C, workflow analyzer 103 can identify a dependency violation when a produce attempts to start an event 131L before uploading handouts 131G. Workflow analyzer 103 can also identify other types of workflow violations and notify users as appropriate.

Accordingly, workflow analyzer 103 can maintain calendar 124 and task list 126 and issue notifications 127 based on the application of actions 128 to workflow 121. FIG. 1D illustrates an example of task list 126 and calendar 124 that can be used to as a guide to managing an event represented by workflow 121. As depicted in FIG. 1D, task list 126 includes tasks waiting to be completed as well as upcoming tasks for the week. Calendar 124 indicates the timeframe (day, week, etc.) for which task list 126 is being presented.

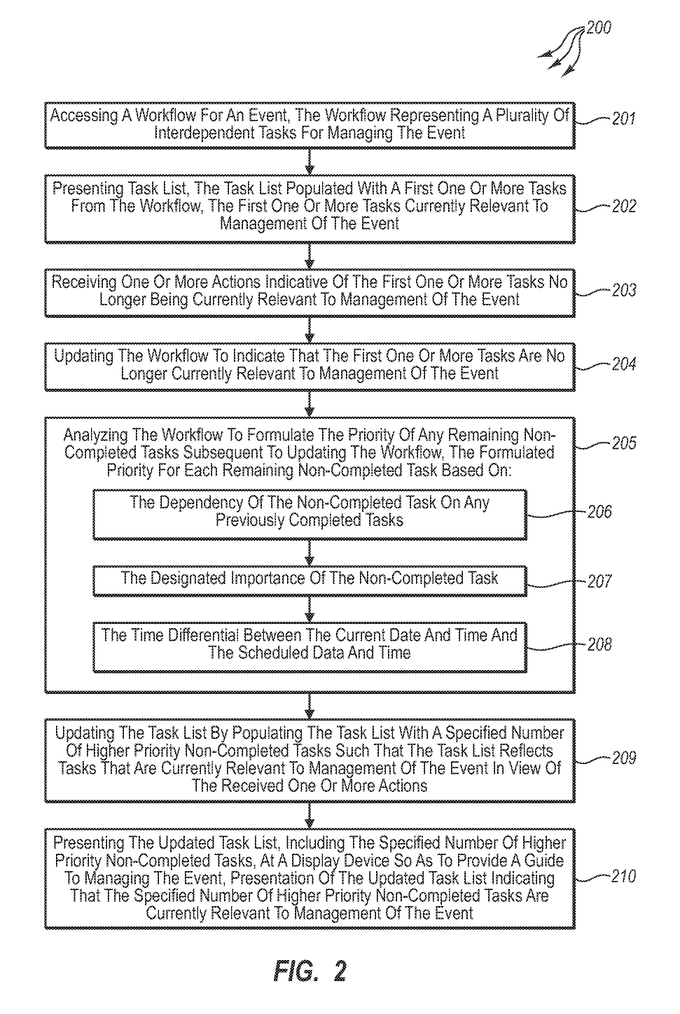

FIG. 2 illustrates a flow chart of an example method 200 for maintaining a task list for an event. Method 200 will be described with respect to the components and data depicted in computer architecture 100.

Method 200 includes an act of accessing a workflow for an event, the workflow representing a plurality of interdependent tasks for managing the event (act 201). For example, workflow analyzer can access workflow 121. Workflow 121 represents a plurality of interdependent tasks for managing an event (e.g., a gathering of human attendees). An event can include in-person attendees as well as virtual attendees. An in-person attendee attends an event in a physical location where a presenter is presenting. A virtual attendee can attend an event virtually via electronic communication between the physical location of a presenter and the physical location of virtual attendee (e.g., video teleconference, Web cast, etc.)

Method 200 includes an act of presenting a task list, the task list populated with a first one or more tasks from the workflow, the first one or more tasks currently relevant to management of the event (act 202). For example, workflow analyzer 103 can present task list 126 through user interface 102. Task list 126 is populated with tasks relevant to the management of the event based on the current state of workflow 121. Relevant tasks can include higher priority tasks.

Method 200 includes an act of receiving one or more actions indicative of the first one or more tasks no longer being currently relevant to management of the event (act 203). For example, workflow analyzer 103 can receive actions 128 from entities 106. Actions 128 can indicate that one or more tasks in task list 124 are no longer relevant to managing the event corresponding to workflow 121.

Actions 128 can include manually performed actions (e.g., creating an invitee list) from a human, such as, for example, human 106C. Actions 128 can also include automated actions (sending invitation emails) from a computer system, such as, for example, computer system 106B. Actions 128 can also include detecting a specified date and time, such as, for example, based on clock 106A. Actions 128 can also include actions in which two or more of entities 106 interoperate to generate the action. Generally, actions can indicate that a task is no long relevant in a variety of ways. For example, actions 128 can indicate that a task is completed, that the importance of the task has been decreased, etc.

Generally, an event command can also be used to indicate that a task is no longer relevant. For example, event command 122 can indicate the a task is to be removed from workflow 121, that a task be changed from required to optional, or that importance for a task has changed,

Method 200 includes an act of updating the workflow to indicate that the first one or more tasks are no longer currently relevant to management of the event (act 204). For example, based on actions 128 and/or event command 122, workflow analyzer 103 can update workflow 121 to indicate that one or more tasks currently in task list 126 are no longer relevant to managing the event. A task may no longer be relevant for any number of different reasons. For example, workflow analyzer 103 can determine that a task is complete based on actions 128. Similarly, workflow analyzer 103 can lower the importance of a task based on actions 128. Workflow analyzer 103 can also detect workflow changes received in an event command and determine task relevancy accordingly. For example, workflow analyzer 103 can determine when a task is removed from workflow 121, when a task in workflow 121 is changed from required to optional, when the importance of a task in workflow 121 is change, and when the time for completing an optional task has passed.

Method 200 includes an act of analyzing the workflow to formulate the priority of any remaining non-completed tasks subsequent to updating the workflow (act 205). For example, workflow analyzer 103 can analyze workflow 121 to formulate the priority for any remaining non-completed tasks in workflow 121 subsequent to updating workflow 121.

The formulated priority for each remaining non-completed task is based on one or more of the dependency of the non-completed task on any previously completed tasks, the designated importance of the non-completed task, and the time differential between the current date and time and the scheduled data and time.

Dependency of a non-completed task on any previously completed tasks can indicate if the task is in fact ready to be initiated or not. If not, the priority of the task is lowered. Thus, even if a task is of higher importance, the task is given a lower priority if it the task is not yet ready to be initiated due to dependencies. As the time to start the event approaches, the priority of tasks required for starting the event can be increased. Thus, even if a task is of lower importance, the priority of task can be increased if the task might prevent an event from starting.

In some embodiments, workflow analyzer 103 uses an equation to calculate numerical priority values for tasks. The equation receives the dependency of the non-completed task on any previously completed tasks, the designated importance of the non-completed task, and the time differential between the current date and time and the scheduled data and time as inputs. From the inputs, the equation generates a numerical priority value.

Method 200 includes an act of updating the task list by populating the task list with a specified number of higher priority non-completed tasks such that the task list reflects tasks that are currently relevant to management of the event in view of the received one or more actions (act 206). For example, workflow analyzer 103 can populated task list 126 with tasks having higher priority values. For example, referring briefly back to FIG. 1D, the tasks depicted in task list 126 can have higher priority values than at least some other tasks in workflow 121.

Method 200 includes an act of presenting the updated task list, including the specified number of higher priority non-completed tasks, at a display device so as to provide a guide to managing the event, presentation of the updated task list indicating that the specified number of higher priority non-completed tasks are currently relevant to management of the event (act 207). For example, user interface 102 can present task list 126 at display device. Task list 126 can be used as a guide to managing the event corresponding to workflow 121. Presentation of task list 126 can indicate to an event producer that a specified number of higher priority tasks are in need of completion.

Accordingly, the configuration of a task list provides utility to both experienced, professional producers as well as the do it yourself producer. Users can use the task list to drive their event management or they can ignore it. As tasks are completed, they are marked as such. This allows a mix of usages. For example, one event manager, say a presenter, might work only from the task list, whereas the producer does everything directly.

A task list can also contain both optional and required tasks, where the optional tasks are guideposts. When an event passes from pre to in-meeting state, any optional tasks for the prior state are automatically marked as skipped. The task list is also dynamic, as new entries appear based on actions by users, attendees or the system. This provides a flexible and powerful framework for event management.

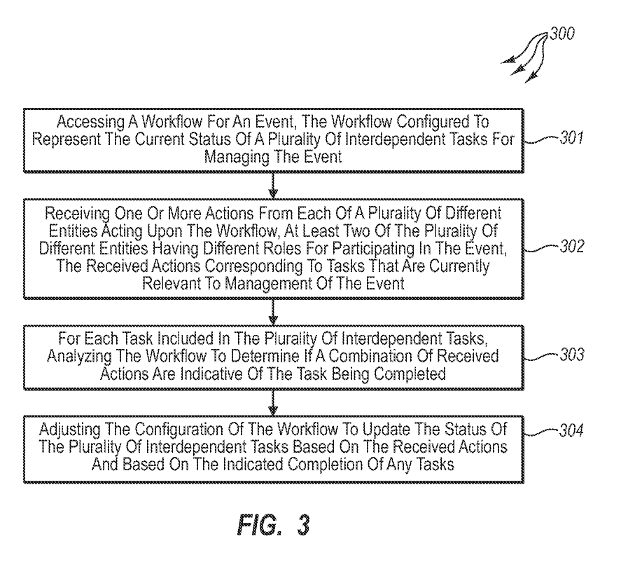

FIG. 3 illustrates a flow chart of an example method 300 for maintaining a workflow for an event. Method 300 will be described with respect to the components and data depicted in computer architecture 100.

Method 300 includes an act of accessing a workflow for an event, the workflow configured to represent the current status of a plurality of interdependent tasks for managing the event (act 301). For example, workflow analyzer 103 can access workflow 121.

Method 300 includes an act of receiving one or more actions from each of a plurality of different entities acting upon the workflow, at least two of the plurality of different entities having different roles for participating in the event, the received actions corresponding to tasks that are currently relevant to management of the event (act 302). For example, workflow analyzer 103 can receive actions 128. At least two actions in actions 128 can be from entities having different roles for participating in an event corresponding to workflow 121. For example, one entity may be an attendee and another entity a presenter. Actions 128 indicate actions relevant to the management of the event corresponding to workflow 121.

Method 300 includes for each task included in the plurality of interdependent tasks, an act of analyzing the workflow to determine if a combination of received actions are indicative of the task being completed (act 303). For example, workflow analyzer 103 can analyzer actions 128 to determine if a combination of received actions are indicative of any tasks in workflow 121 being completed. Method 300 includes an act of adjusting the configuration of the workflow to update the status of the plurality of interdependent tasks based on the received actions and based on the indicated completion of any tasks (act 304). For example, workflow analyzer 103 can adjust the configuration of workflow 121 update the status of core tasks 131, timeline triggered tasks 132, user or system triggered tasks 133, etc., based on actions 128. Some combinations of actions can expressly indicate that a task is completed. From other combinations of actions, workflow analyzer 103 can infer that a task is completed (or at least that it does not require completion). For example, workflow analyzer 103 can determine when the time for completing an optional task has expired.

Referring now to task database 113, task database 113 can be used to store a variety of differently configured tasks. Tasks can be related to any of a variety of different portions of event management. Tasks can include more generalized tasks, such as, for example:

| | | | | | | UI Menu |
|---|---|---|---|---|---|---|
| | | Pre | | | | Area to |
| | Opt/ | In | | | Can Task be Auto | Perform |
| Task Name | Req | Post | Roles | Dependencies/Triggers | Marked as Done | Task |
| Setup Event | Req | Pre | Producer | | Yes | Settings |
| Setup | Opt | Pre | Producer | | No | Settings |
| Registration | | | | | | |
| Setup | Opt | Pre | Producer | | No | Settings |
| Branding | | | | | | |
| Publish | Req | Pre | Producer | Setup Event AND Setup | Yes | Portal |
| Event Portal | | | | Registration | | |
| | | | | OR | | |
| | | | | Triggered if a setting was | | |
| | | | | changed and that change is | | |
| | | | | part of the event portal | | |
| | | | | (e.g. bios, title, event | | |
| | | | | description, registration) | | |
| Create | Opt | Pre | Producer | | No | People |
| Invitee List | | | | | | |
| Send | Opt | Pre | Producer | Create Invitee List AND | No | Email/ |
| Invitations | | | | Publish Event Portal | | Create |
| Send | Opt | Pre | Producer | Create Invitee List AND | No | Email/ |
| Reminders | | | | Publish Event Portal | | Create |
| Review | Opt | Pre | Producer | Triggered by system | No | Email/ |
| Email | | Post | Mail | finished sending an email | | Schedule |
| Results | | | Handler | | | |
| Review | Opt | Pre | Producer | Triggered when | Yes | People |
| Registration | | In | Reg | registration is enabled and | | |
| Requests | | | Handler | a user submitted a new | | |
| | | | | registration (appears once | | |
| | | | | for multiple requests) | | |
| Upload | Opt | Pre | Producer | | No | Content |
| Content | | In | Presenter | | | |
| Answer | Opt | Pre | Producer | Triggered when attendee | Yes | Content/ |
| Question | | In | Presenter | asks a question on event | | Q&A |
| | | | SME | portal (appears once for | | |
| | | | | multiple questions) | | |
| Publish | Opt | Post | Producer | Triggered if event is | Yes | Settings |
| Recording | | | | recorded, AND End Event | | |
| | | | | AND the event was not set | | |
| | | | | to automatically convert | | |
| Send | Opt | Post | Producer | End Event AND Publish | No | Email/ |
| Follow-ups | | | | Event Portal | | Create |
| Archive/Delete | Opt | Post | Producer | End Event AND Publish | Yes | Settings |
| Event | | | | Event Portal | | |

Tasks can also include one or more tasks specific to portions of a user interface, such as, for example:

| | | | | | | | UI Menu |
|---|---|---|---|---|---|---|---|
| UI Menu | | | Pre | | | Can Task be | Area to |
| Area to | | Opt/ | In | | | Auto Marked | Perform |
| Perform Task | Task Name | Req | Post | Roles | Dependencies/Triggers | as Done | Task |
| Branding | Upload Logos | Opt | Pre | Producer | | No | Branding |
| Branding | Specify | Opt | Pre | Producer | | No | Branding |
| | Colors and | | | | | | |
| | Background | | | | | | |
| Branding | Select Fonts | Opt | Pre | Producer | | No | Branding |
| | and | | | | | | |
| | Formatting | | | | | | |
| Email/ | Specify To- | Opt | Pre | Producer | | Yes | Email/ |
| Create | List | | Post | | | | Create |
| Email/ | Specify From | Opt | Pre | Producer | | Yes | Email/ |
| Create | Email | | Post | | | | Create |
| Email/ | Specify | Opt | Pre | Producer | | Yes | Email/ |
| Create | Subject | | Post | | | | Create |
| Email/ | Select Email | Opt | Pre | Producer | | Yes | Email/ |
| Create | Template | | Post | | | | Create |
| Email/ | Check | Opt | Pre | Producer | | No | Email/ |
| Create | Preview | | Post | | | | Create |
| Content/ | Upload | Opt | Pre | Producer | | No | Content/ |
| Presentation | Presentation | | | Presenter | | | Presentation |
| Content/ | Upload | Opt | Pre | Producer | | No | Content/ |
| Handouts | Handouts | | | Presenter | | | Handouts |
| Content/ | Upload Lobby | Opt | Pre | Producer | | Yes | Content/ |
| Lobby | | | | Presenter | | | Lobby |
| Content/ | Create Polls | Opt | Pre | Producer | | No | Content/ |
| Presentation | | | | Presenter | | | Presentation |
| Settings | Check Live | Opt | Pre | Producer | | No | Settings |
| | Event Settings | | | | | | |
| | for Q&A, | | | | | | |
| | Chat | | | | | | |
| Settings | Select Audio | Opt | Pre | Producer | | No | Settings |
| | Options | | | | | | |
| Settings | Setup Dial-In | Req | Pre | Producer | Triggered if PSTN is | Yes | Settings |
| | | | | | enabled | | |
| Settings | Set Recording | Opt | Pre | Producer | | No | Settings |
| | and Automatic | | | | | | |
| | Conversion | | | | | | |
| Settings | Set Content | Opt | Pre In | Producer | | No | Settings |
| | Expiration | | Post | | | | |
| Portal | Set Title | Req | Pre | Producer | | Yes | Settings |
| Portal | Set Date/Time | Req | Pre | Producer | Triggered if meeting type is | Yes | Settings |
| | | | | | ‘Live’ | | |
| Portal | Set | Opt | Pre | Producer | | Yes | Settings |
| | Description | | | | | | |
| Portal | Set Presenters | Opt | Pre | Producer | | No | People/ |
| | | | | | | | Managers |
| Portal | Specify | Opt | Pre | Producer | | No | Settings |
| | Contact Email | | | | | | |
| Portal | Set Branding | Opt | Pre | Producer | | No | Branding |
| Portal | Preview Portal | Opt | Pre | Producer | | No | Portal |
| Portal | Publish Portal | Req | Pre | Producer | Triggered if a setting was | Yes | Portal |
| | | | Post | | changed and that change is | | |
| | | | | | part of the event portal (e.g: | | |
| | | | | | bios, title, event description) | | |
| Registration | Set Times | Opt | Pre | Producer | | No | Settings |
| Registration | Select | Opt | Pre | Producer | | No | Settings |
| | Approval | | | | | | |
| | Type | | | | | | |
| Registration | Create Survey | Opt | Pre | Producer | | Yes | Settings |
| Registration | Select Email | Opt | Pre | Producer | Select Approval Type | No | Settings |
| | Templates | | | | | | |
| Registration | Preview | Opt | Pre | Producer | Create Survey | No | Settings |
| | Registration | | | | | | |
| | Page | | | | | | |

Thus, in some embodiments a multiple people acting in different roles can simultaneously impact a workflow and/or timeline for an event. For example, an event manager can perform some tasks, a presenter can perform other different tasks, an attendee can perform additional other tasks, etc. Each person associated with an event can have their own to-do list (e.g., similar to task list 126). To-do lists for different people can have overlapping tasks and multiple people can have the same role.

Accordingly, embodiments of the invention combine intelligent analysis of workflow along with a timelines to manage events. Embodiments can be used to generate a dynamic task list (or progress indicator) per individual that shows tasks that have been completed, tasks that can be done now, and remaining tasks. Thus, the task list acts as a guide and a measure of progress. The task list also increases the chance that tasks are completed in the proper order.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method for maintaining a task list for an event, the method comprising:
an act of accessing a workflow for an event, the workflow representing a plurality of interdependent tasks for managing the event;
an act of presenting task list, the task list populated with a first one or more tasks from the workflow, the first one or more tasks currently relevant to management of the event;
an act of receiving one or more actions indicative of the first one or more tasks no longer being currently relevant to management of the event;
an act of updating the workflow to indicate that the first one or more tasks are no longer currently relevant to management of the event;
an act of analyzing the workflow to formulate the priority of any remaining non-completed tasks subsequent to updating the workflow, the formulated priority for each remaining non-completed task based on:
the dependency of the non-completed task on any previously completed tasks;
the designated importance of the non-completed task; and
the time differential between the current date and time and the scheduled data and time; and
an act of updating the task list by populating the task list with a specified number of higher priority non-completed tasks such that the task list reflects tasks that are currently relevant to management of the event in view of the received one or more actions; and
an act of presenting the updated task list, including the specified number of higher priority non-completed tasks, at a display device so as to provide a guide to managing the event, presentation of the updated task list indicating that the specified number of higher priority non-completed tasks are currently relevant to management of the event.

2. The method as recited in claim 1, further comprising:
an act of receiving event data defining the event, the event data indicating at least a scheduled date and time for the event and an event type for the event;
an act of accessing an event template for the event type;
an act of creating a workflow for the event based on the event template and in accordance with the received event data, the workflow representing a plurality of interdependent tasks for the event; and
an act of generating a initially task list for presenting actionable tasks to be completed for the event.

3. The method as recited in claim 2, wherein an act of receiving event data defining the event comprises an act of receiving settings for customizing the workflow; and further comprising:
an act of customizing the workflow in accordance with the received settings.

4. The method as recited in claim 2, wherein an act of creating a workflow for the event based on the event template and in accordance with the received event data comprises an act of creating a hybrid polyarchical tree of tasks that is stratified based on how tasks are triggered.

5. The method as recited in claim 2, wherein an act of creating a workflow for the event comprises an act of creating a workflow for an event that is to include one or more attendees via video teleconference or Webcast.

6. The method as recited in claim 1, wherein the act of presenting task list comprises an act of presenting a list of tasks that can currently be completed and a list of tasks that can be completed in the future.

7. The method as recited in claim 1, wherein the act of receiving one or more actions indicative of the first one or more tasks no longer being currently relevant to management of the event comprises an act of receiving an action form one or more of a clock, a computer system, and a human user.

8. The method as recited in claim 1, wherein the act of receiving one or more actions indicative of the first one or more tasks no longer being currently relevant to management of the event comprises an act of receiving one or more actions indicative of a task being completed.

9. The method as recited in claim 8, wherein the act of receiving one or more actions indicative of a task being completed comprises an act of receiving one or more actions indicative of the time for completing an optional task expiring.

10. The method as recited in claim 1, wherein the an act of receiving one or more actions indicative of the first one or more tasks no longer being currently relevant to management of the event comprises an act of receiving one or more actions indicative of the importance of a task being reduced.

11. The method as recited in claim 1, wherein an act of updating the workflow to indicate that the first one or more tasks are no longer currently relevant to management of the event comprises an act of update the workflow state to indicate that some of the first one or more tasks have been completed.

12. The method as recited in claim 1, wherein the act of analyzing the workflow to formulate the priority of any remaining non-completed tasks subsequent to updating the workflow comprises an act of formulating a priority for at least one of a timeline triggered task and a user trigged task.

13. The method as recited in claim 1, wherein the act of analyzing the workflow to formulate the priority of any remaining non-completed tasks subsequent to updating the workflow comprises an act of formulating a priority for at least on task based on the completion of tasks that task depended on.

14. At a computer system including one or more processors and system memory, the computer system also including a workflow for managing an event timeline for an event, a method for maintaining the workflow, the method comprising:
an act of accessing a workflow for an event, the workflow configured to represent the current status of a plurality of interdependent tasks for managing the event;
an act of receiving one or more actions from each of a plurality of different entities acting upon the workflow, at least two of the plurality of different entities having different roles for participating in the event, the received actions corresponding to tasks that are currently relevant to management of the event;
for each task included in the plurality of interdependent tasks, an act of analyzing the workflow to determine if a combination of received actions are indicative of the task being completed; and
an act of adjusting the configuration of the workflow to update the status of the plurality of interdependent tasks based on the received actions and based on the indicated completion of any tasks.

15. The method as recited in claim 14, further comprising:
an act of analyzing the adjusted configuration of the workflow to formulate the priority of any remaining non-completed tasks in the plurality of interdependent tasks, the formulated priority for each remaining non-completed task based on:
the dependency of the non-completed task on any previously completed tasks;
the designated importance of the non-completed task; and
the time differential between the current date and time and the scheduled data and time; and
an act of populating a task list with a specified number of higher priority non-completed tasks such that the task list reflects tasks that are currently relevant to management of the event in view of any received actions; and
an act of presenting the task list, including the specified number of higher priority non-completed tasks, at a display device so as to provide a guide to managing the event, presentation of the task list indicating that the specified number of higher priority non-completed tasks are currently relevant to management of the event.

16. The method as recited in claim 14, further comprising:
an act of determining that actions indicating completion of task violate the dependency conditions of the task; and
an act of sending a notification to alert an event participant to the violation.

17. The method as recited in claim 14, wherein an act of receiving one or more actions from each of a plurality of different entities acting upon the workflow comprises an act of receiving actions from an entity having a role selected from among: all participants, approved participants, registered participants, attendees, company, presenters, producer, mail handler, and registration handler.

18. The method as recited in claim 14, wherein the act of analyzing the workflow to determine if a combination of received actions are indicative of the task being completed comprises an act of analyzing the workflow to determine that the time for completing an optional task has expired.

19. The method as recited in claim 14, wherein the act adjusting the configuration of the workflow to update the status of the plurality of interdependent tasks comprises an act of updating workflow state to indicate that a task is completed.

20. An event management system for managing events that are to include human attendees, the system comprising:
system memory;
one or more processors;
one or more computer storage media having stored thereon one or more event templates, an event database, and a task database, the computer storage media also having stored thereon computer-executable instructions representing an event module, a workflow analyzer, and a user-interface, wherein the event module is configured to:
process event data defining an event, the event data indicating at least a scheduled date and time for the event and an event type for the event;
access an event template for the event type;
create an event workflow for the event based on the event template and in accordance with the received event data, the event workflow configured to represent the current status of a plurality of interdependent tasks for the managing event;
wherein the workflow analyzer is configured to:
access an event workflow for an event;
an act of receiving one or more actions from each of a plurality of different entities acting upon the event workflow, at least two of the plurality of different entities having different roles for participating in the event, the received actions corresponding to tasks that are currently relevant to management of the event, the plurality of different entities including a clock, a computer system, and a human user;
for each task included in the plurality of interdependent tasks, analyze the workflow to determine if a combination of received actions are indicative of the task being completed;
update the event workflow to indicate tasks are that are no longer currently relevant to management of the event;
analyze the event workflow to formulate a task priority for tasks subsequent to updating the workflow, the formulated task priority for each task based on:
the dependency of the task on any previously completed tasks;
the designated importance of the task; and
the time differential between the current date and time and the scheduled data and time; and
update the task list by populating the task list with a specified number of higher priority tasks such that the task list reflects tasks that are currently relevant to management of the event in view of the received one or more actions; and
wherein the user-interface is configured to:
receive event data defining an event, the event data indicating at least a scheduled date and time for the event and an event type for the event; and
present the updated task list, including the specified number of higher priority tasks, at a display device so as to provide a guide to managing the event, presentation of the updated task list indicating that the specified number of higher priority tasks are currently relevant to management of the event.
